(19) United States
(12) Patent Application Publication
(10) Pub. No.: US 2025/0297345 A1
(43) Pub. Date: Sep. 25, 2025

(54) RIBBON AND METHOD FOR MANUFACTURING HOT DEFORMED MAGNET

(71) Applicant: TDK CORPORATION, Tokyo (JP)

(72) Inventors: Mutsuki SAITO, Tokyo (JP); Lihua Liu, Tokyo (JP)

(73) Assignee: TDK CORPORATION, Tokyo (JP)

(21) Appl. No.: 19/077,135

(22) Filed: Mar. 12, 2025

(30) Foreign Application Priority Data
Mar. 25, 2024 (JP) 2024-048002
Jan. 9, 2025 (JP) 2025-003618

(51) Int. Cl. C22C 38/00; B22F 3/14; B22F 9/00; B22F 9/04; C22C 38/10; H01F 1/057

(52) U.S. Cl. CPC C22C 38/005; B22F 3/14; B22F 9/008; B22F 9/04; C22C 38/002; C22C 38/10; H01F 1/0571; B22F 2201/11; B22F 2301/355; B22F 2998/10; B22F 2999/00; C22C 2202/02

(57) ABSTRACT

A ribbon contains an alloy containing a rare earth element, iron, and boron. The ribbon has a surface R and a surface F located on a back side of the surface R. The surface R includes an amorphous region where only an amorphous phase of the alloy is exposed. The surface F includes a crystalline region where at least a crystalline phase of the alloy is exposed. The plurality of recesses are formed in the crystalline region. The surface R does not include the crystalline region where the plurality of recesses are formed.

### CROSS-REFERENCE TO RELATED APPLICATIONS

This application is based upon and claims the benefit of priority from Japanese Patent Application No. 2025-003618, filed on Jan. 9, 2025, and Japanese Patent Application No. 2024-048002, filed on Mar. 25, 2024, the entire contents of which are incorporated herein by reference.

### BACKGROUND

### Field

The present disclosure relates to a ribbon and a method for manufacturing a hot deformed magnet.

### Description of the Related Art

Generally, a hot deformed magnet is manufactured from an alloy ribbon. (See Japanese Unexamined Patent Publication No. 2013-135142 and Japanese Unexamined Patent Publication No. 2013-84802.) For example, the alloy ribbon is prepared by a rapid-solidification method. In the rapid-solidification method, a molten metal containing a rare earth element R, a transition metal element T, and boron (B) is rapidly cooled on a surface of a cooled roll. As a result, the molten metal is solidified to form an alloy ribbon. By pulverizing the alloy ribbon, an alloy powder is obtained. By hot-pressing the alloy powder, a compact is obtained. By hot-deforming the compact, a hot deformed magnet is obtained.

### SUMMARY

An object of one aspect of the present disclosure is to provide a ribbon for increasing a density of a compact formed from the ribbon, and a method for manufacturing a hot deformed magnet using the ribbon as a raw material.

For example, as described below, one aspect of the present disclosure relates to a ribbon according to any one of [1] to [10], and a method for manufacturing a hot deformed magnet according to [11].
[1] A ribbon containing an alloy containing a rare earth element, iron, and boron, in which
the ribbon has a surface R and a surface F located on a back side of the surface R,
the surface R includes an amorphous region where only an amorphous phase of the alloy is exposed,
the surface F includes a crystalline region where at least a crystalline phase of the alloy is exposed,
a plurality of recesses are formed in the crystalline region, and
the surface R does not include the crystalline region where the plurality of recesses are formed.
[2] The ribbon according to [1], in which
the surface F further includes a region where the amorphous phase is exposed in addition to the crystalline region.
[3] The ribbon according to [1] or [2], in which
the amorphous phase is exposed in at least one of the plurality of recesses.
[4] The ribbon according to any one of [1] to [3], in which
the amorphous phase is exposed in at least one of the plurality of recesses, and
an area ratio of the crystalline phase in the crystalline region is from 0.18 to 0.90.
[5] The ribbon according to any one of [1] to [4], in which
the amorphous phase is exposed in at least one of the plurality of recesses,
a circumferential length of one of the recesses observed from a direction perpendicular to the surface F is represented by L,
an area of the one of the recesses observed from the direction perpendicular to the surface F is represented by A, and
L²/A is from 100 to 400.
[6] The ribbon according to [1] or [2], in which
the crystalline phase is exposed in all of the plurality of recesses.
[7] The ribbon according to any one of [1] to [6], in which
the amorphous region includes a plurality of recessed curved surfaces.
[8] The ribbon according to any one of [1] to [7], which is used as a raw material of a hot deformed magnet.
[9] The ribbon according to any one of [1] to [8], in which
the ribbon has a thickness of from 10 μm to 60 μm.
[10] The ribbon according to any one of [1] to [9], in which
a volume of the crystalline phase included in the ribbon is represented by V_{C},
a volume of the amorphous phase included in the ribbon is represented by V_{A}, and
V_{C}/(V_{C}+V_{A}) is more than 0 and 0.40 or less.
[11] A method for manufacturing a hot deformed magnet, including:
a step of pulverizing the ribbon according to any one of [1] to [10] to obtain an alloy powder;
a step of pressurizing the alloy powder while heating the alloy powder to obtain a compact; and
a step of hot-deforming the compact to obtain a magnet base material.

According to one aspect of the present disclosure, there is provided a ribbon for increasing a density of a compact formed from the ribbon, and a method for manufacturing a hot deformed magnet using the ribbon as a raw material.

### BRIEF DESCRIPTION OF THE DRAWINGS

FIG. 1A is a schematic perspective view of a specific example of a ribbon, FIG. 1B is a schematic view of a cross section of the ribbon of FIG. 1A, and the cross section of FIG. 1B is parallel to a thickness direction Z (YZ plane) of the ribbon.

FIG. 2 is an enlarged view of a part (region II) of the cross section of FIG. 1B.

FIG. 3A is a backscattered electron image of a surface F of the specific example of the ribbon, FIG. 3B is a backscattered electron image of a surface R of the specific example of the ribbon, and the two backscattered electron images shown in FIG. 3A and FIG. 3B are images taken at the same magnification.

FIG. 4A is a backscattered electron image of a crystalline region (part of the surface F) of the specific example of the ribbon, FIG. 4B is a backscattered electron image of an amorphous region (part of the surface R) of the specific example of the ribbon, and the two backscattered electron images shown in FIG. 4A and FIG. 4B are images taken at the same magnification and are images taken at a higher magnification than that of the two backscattered electron images shown in FIG. 3A and FIG. 3B.

FIG. 5A is a backscattered electron image of the crystalline region (part of the surface F) of the specific example of the ribbon, FIG. 5B is a backscattered electron image of the amorphous region (part of the surface R) of the specific example of the ribbon, and the two backscattered electron images shown in FIG. 5A and FIG. 5B are images taken at the same magnification and are images taken at a higher magnification than that of the two backscattered electron images shown in FIG. 4A and FIG. 4B.

FIG. 6 is an enlarged view of a part of the backscattered electron image (crystalline region) shown in FIG. 4A.

FIG. 7A is a schematic perspective view of a hot deformed magnet manufactured from a ribbon, FIG. 7B is a schematic view of a cross section of the hot deformed magnet of FIG. 7A (arrow view taken along a line b-b in the hot deformed magnet), a cross section of FIG. 7B is parallel to an easy magnetization axis direction C of the hot deformed magnet, and FIG. 7C is an enlarged view of a part (region VII) of the cross section of FIG. 7B.

FIG. 8 is a schematic diagram (cross-sectional view) illustrating a method for manufacturing a ribbon (rapid-solidification method described later).

### DETAILED DESCRIPTION

In the following description, with reference to the drawings, the same reference numbers are assigned to the same components or to similar components having the same function, and overlapping description is omitted. The present disclosure is not limited to the following embodiment. X, Y, and Z shown in each drawing mean three coordinate axes orthogonal to each other. Each of directions of the X-axis, the Y-axis, and the Z-axis is common to the drawings.

A ribbon according to the present disclosure may be used as a raw material of a hot deformed magnet. In the present disclosure, an alloy powder is a pulverized ribbon. That is, the alloy powder and individual alloy particles constituting the alloy powder are substantially the same as the ribbon except that the alloy powder and the individual alloy particles have been subjected to a pulverization step.

### (Composition of Ribbon)

The ribbon contains an alloy. The alloy contained in the ribbon contains a rare earth element R, a transition metal element T, and boron (B). The ribbon may consist only of an alloy. The ribbon may further contain trace amounts of other components (for example, a simple metal or inevitable impurities) in addition to the alloy.

The alloy contained in the ribbon contains at least neodymium (Nd) as the rare earth element R. The alloy may further contain another rare earth element R in addition to Nd. The other rare earth element R contained in the alloy may be at least one element selected from the group consisting of scandium (Sc), yttrium (Y), lanthanum (La), cerium (Ce), praseodymium (Pr), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu). The alloy need not contain of a heavy rare earth element (for example, both Dy and Tb).

The alloy contained in the ribbon contains at least iron (Fe) as the transition metal element T. The alloy may contain only Fe as the transition metal element T. The alloy may contain both Fe and cobalt (Co) as the transition metal element T.

The composition of the alloy contained in the ribbon may be represented by R₂T₁₄B. R₂T₁₄B is a ternary intermetallic compound being magnetically hard. R₂T₁₄B may be represented by (Nd₁₋ₓPrₓ)₂(Fe_{1-y}Co_{y})₁₄B. x may be 0 or more and less than 1. y may be 0 or more and less than 1. R₂T₁₄B may contain a heavy rare earth element such as Tb and Dy as the rare earth element R in addition to a light rare earth element. R₂T₁₄B may contain another element in addition to R, T, and B. For example, a part of B in R₂T₁₄B may be replaced with another element such as carbon (C).

The content of the rare earth element R in the alloy contained in the ribbon may be from 26.00% by mass to 33.00% by mass. The total ratio of Nd and Pr in all the rare earth elements R may be from 80 atom % to 100 atom %. The total content of Tb and Dy in the alloy may be from 0.00% by mass to 5.00% by mass. Tb and Dy are not essential elements for the alloy contained in the ribbon.

The content of B in the alloy contained in the ribbon may be from 0.75% by mass to 1.20% by mass.

The alloy contained in the ribbon may contain gallium (Ga). The content of Ga in the alloy may be from 0.03% by mass to 1.00% by mass. Ga is not an essential element for the alloy contained in the ribbon.

The alloy contained in the ribbon may contain aluminum (Al). The content of Al in the alloy may be from 0.01% by mass to 0.2% by mass. Al is not an essential element for the alloy contained in the ribbon.

The alloy contained in the ribbon may contain copper (Cu). The content of Cu in the alloy may be from 0.01% by mass to 1.50% by mass. Cu is not an essential element for the alloy contained in the ribbon.

The alloy contained in the ribbon may contain cobalt (Co). The content of Co in the alloy may be from 0.30% by mass to 6.00% by mass. Co is not an essential element for the alloy contained in the ribbon.

The balance obtained by removing the above elements from the alloy contained in the ribbon may be only Fe or Fe and other elements. The total content of elements other than Fe in the balance may be 5% by mass or less with respect to the total mass of the alloy. For example, the alloy contained in the ribbon may contain, as other elements (for example, inevitable impurities), at least one element selected from the group consisting of silicon (Si), titanium (Ti), Mn (manganese), Zr (zirconium), vanadium (V), chromium (Cr), nickel (Ni), niobium (Nb), molybdenum (Mo), hafnium (Hf), tantalum (Ta), tungsten (W), bismuth (Bi), tin (Sn), calcium (Ca), carbon (C), nitrogen (N), oxygen (O), chlorine (Cl), sulfur (S), and fluorine (F). The total content of other elements in the alloy may be from 0.0010% by mass to 0.50% by mass.

The composition of the ribbon may be analyzed by, for example, an X-ray fluorescent (XRF) analysis method, a high frequency inductively coupled plasma (ICP) emission analysis method, an inert gas fusion-non-dispersive infrared absorption (NDIR) method, a combustion-infrared absorption method in an oxygen stream, or an inert gas fusion-thermal conductivity method.

### (Structure, Crystalline Property, and Amorphous Property of Ribbon)

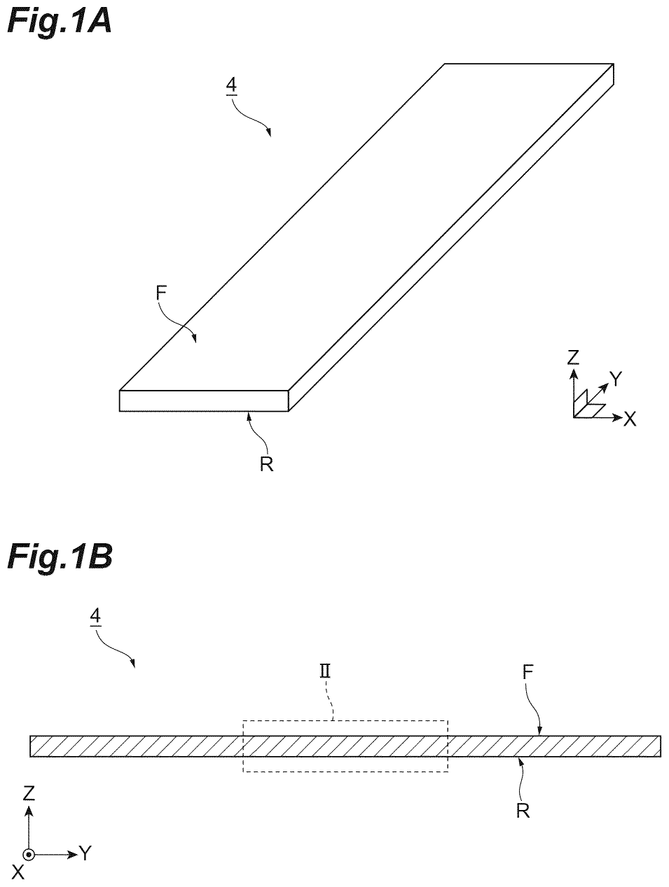

As shown in FIG. 1A and FIG. 1B, a ribbon 4 has a surface R and a surface F located on a back side of the surface R.

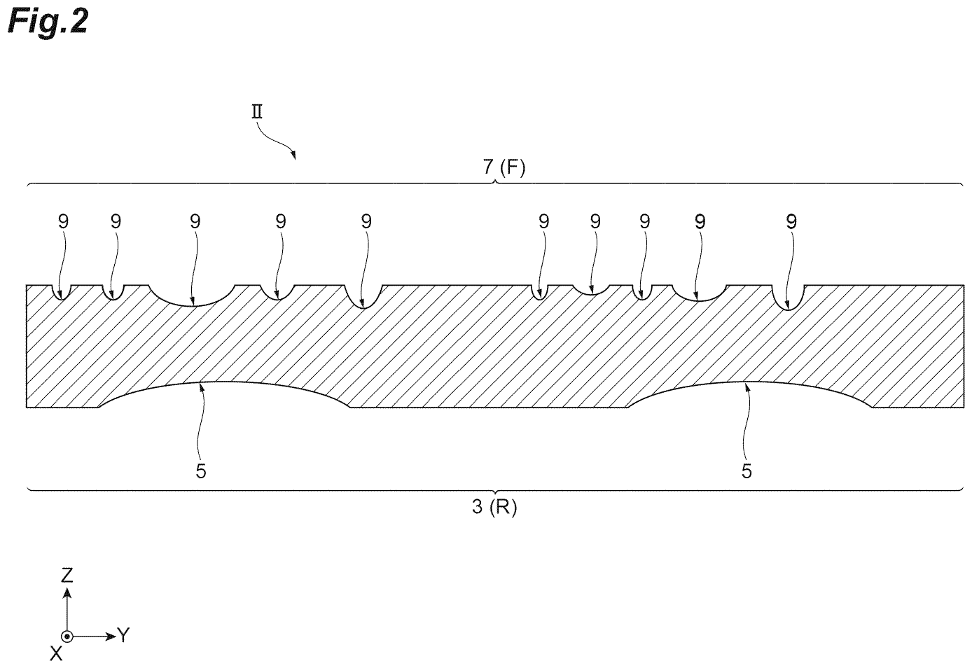

As shown in FIG. 2, the surface R includes an amorphous region 3 where only an amorphous phase of the alloy is exposed. That is, at least a part of the surface R is the amorphous region 3. The entire surface R may be the amorphous region 3. That is, only the amorphous phase of the alloy may be exposed on the entire surface R.

On the other hand, the surface F includes a crystalline region 7 where at least a crystalline phase of the alloy is exposed. That is, at least a part of the surface F is the crystalline region 7. The entire surface F may be the crystalline region 7. A plurality of recesses 9 (depressions) are formed in the crystalline region 7. The amorphous phase of the alloy may be exposed in a portion other than the crystalline region in the surface F.

The surface R does not include the crystalline region 7 where the plurality of recesses 9 are formed. Therefore, the surface R and the surface F can be distinguished from each other on the basis of presence or absence of the crystalline region 7 where the plurality of recesses 9 are formed. The amorphous region 3 in the surface R may be located on a back side of the crystalline region 7 in the surface F. Note that the feature “the surface R does not include the crystalline region 7 where the plurality of recesses 9 are formed” means that the crystalline region 7 where the plurality of recesses 9 are formed is not substantially observed on the surface R.

For example, an amorphous property of the amorphous region 3 and a crystalline property of the crystalline region 7 may be confirmed by one or more analysis methods selected from the group consisting of thin film X-ray diffraction, a transmission electron microscope (TEM), a scanning transmission electron microscope (STEM), and a scanning electron microscope (SEM).

The crystalline phase of the alloy may contain a single crystal of R₂T₁₄B or a polycrystal of R₂T₁₄B. The crystalline phase of the alloy may consist only of crystals of R₂T₁₄B. The crystal of R₂T₁₄B may be a tetragonal crystal. For example, a crystal axis (primitive translation vector) of R₂T₁₄B may be represented by an a-axis, a b-axis, and a c-axis. The a-axis, the b-axis, and the c-axis may be orthogonal to each other. A lattice constant of R₂T₁₄B in the a-axis direction may be equal to a lattice constant of R₂T₁₄B in the b-axis direction, and a lattice constant of R₂T₁₄B in the c-axis direction may be different from the lattice constant of R₂T₁₄B in each of the a-axis direction and the b-axis direction. The c-axis of R₂T₁₄B included in a hot deformed magnet manufactured from the ribbon 4 may be substantially or completely parallel to an easy magnetization axis direction C of the hot deformed magnet. In other words, the (001) plane of the tetragonal crystal of R₂T₁₄B included in a hot deformed magnet manufactured from the ribbon 4 may be substantially or completely perpendicular to the easy magnetization axis direction C of the hot deformed magnet.

In a hot pressing step described later, a compact is formed by heating and pressurizing the plurality of pulverized ribbons 4. At an early stage of the hot pressing step, since a pressure acting on the plurality of ribbons 4 is relatively low, each of the plurality of ribbons 4 easily moves. Therefore, at the early stage of the hot pressing step, each of the plurality of ribbons 4 rotates and moves as the plurality of ribbons 4 are pressurized, and a gap between the plurality of ribbons 4 does not increase.

However, as a frictional force acting on the plurality of ribbons 4 increases, the rotation and movement of the plurality of ribbons 4 are more hindered, the gap between the plurality of ribbons 4 is less likely to decrease, and a density of the compact decreases. The frictional force acting on the plurality of ribbons 4 increases due to adhesion between the plurality of ribbons 4. In other words, the frictional force acting on the plurality of ribbons 4 increases as a contact area between the plurality of ribbons 4 increases.

The amorphous region 3 included in the surface R of each of the plurality of ribbons 4 is easily softened or liquefied as the temperature rises, and lubricates the plurality of ribbons 4. As a result, the frictional force acting on the plurality of ribbons 4 is reduced, the rotation and movement of the plurality of ribbons 4 are promoted, the gaps between the plurality of ribbons 4 are reduced, and the density of the compact is increased. In particular, when the surfaces R of the plurality of ribbons 4 are in contact with each other, the frictional force acting on the plurality of ribbons 4 is easily reduced. As the density of the compact increases, a residual magnetic flux density of a hot deformed magnet formed from the compact also increases.

In contrast to the amorphous region 3, the crystalline region 7 included in the surface F of each of the plurality of ribbons 4 is hardly softened or liquefied as the temperature rises. Therefore, the crystalline region 7 hardly contributes to lubricity of the plurality of ribbons 4. In particular, when the surfaces F of the plurality of ribbons 4 are in contact with each other, a frictional force easily acts on the plurality of ribbons 4, and the rotation and movement of the plurality of ribbons 4 are easily hindered. However, the plurality of recesses 9 formed in the crystalline region 7 become gaps between the plurality of ribbons 4, and suppresses adhesion between the plurality of ribbons 4. In other words, the plurality of recesses 9 formed in the crystalline region 7 reduce a substantial contact area between the plurality of ribbons 4. Even if the surfaces F of the plurality of ribbons 4 are in contact with each other, the plurality of recesses 9 formed in the crystalline region 7 can suppress adhesion between the plurality of ribbons 4. Therefore, the plurality of recesses 9 formed in the crystalline region 7 reduce the frictional force acting on the plurality of ribbons 4, and the rotation and movement of the plurality of ribbons 4 are hardly hindered by the frictional force. As a result, the gaps between the plurality of ribbons 4 are reduced, a density of the compact is increased, and a residual magnetic flux density of a hot deformed magnet formed from the compact also increases.

At a final stage of the hot pressing step in which a pressure acting on the plurality of ribbons 4 is relatively high, the plurality of ribbons 4 are compressed, and the plurality of ribbons 4 are disposed in the compact such that the gaps between the plurality of ribbons 4 are substantially or completely eliminated.

The surface F may further include a region where the amorphous phase is exposed in addition to the crystalline region 7 where the plurality of recesses 9 are formed. When the surface F further includes a region where the amorphous phase is exposed, the amorphous phase in the surface F is gradually crystallized while being gently incorporated into the crystalline region 7 during the hot pressing step. Therefore, rapid crystal growth of the alloy is suppressed, coarse crystal grains of the alloy are hardly formed, and a coercivity of a hot deformed magnet manufactured from the plurality of ribbons 4 is improved.

In a conventional hot pressing step, as the temperature of a plurality of ribbons is lower, each of the ribbons is less likely to be softened or liquefied, and a compact is less likely to be densified. On the other hand, according to the present embodiment, even when a hot pressing temperature is low to such an extent that formation of coarse crystal grains is suppressed, the compact becomes dense and the density of the compact increases by the mechanism described above. As a result, a residual magnetic flux density of a hot deformed magnet formed from the compact also increases. In other words, according to the present embodiment, formation of coarse crystal grains during the hot pressing step is suppressed without sacrificing the residual magnetic flux density of the hot deformed magnet, and a high coercivity of the hot deformed magnet is easily obtained.

The amorphous phase may be exposed in at least one of the plurality of recesses 9 formed in the crystalline region 7. The amorphous phase may be exposed in all of the plurality of recesses 9. In the compact after completion of the hot pressing step, remaining of the gaps derived from the plurality of recesses 9 may rather decrease the density of the compact. However, when the amorphous phase is exposed in at least one of the plurality of recesses 9, the amorphous phase in each of the recesses 9 is softened or liquefied and deforms or moves as the temperature rises during the hot pressing step. As a result, the amorphous phase is filled in each of the recesses 9, a gap derived from each of the recesses 9 hardly remains in the compact, and the density of the compact is improved.

When the amorphous phase is exposed in at least one or all of the plurality of recesses 9, an area ratio of the crystalline phase in the crystalline region 7 may be from 0.18 to 0.90, or from 0.180 to 0.757. The area ratio of the crystalline phase in the crystalline region 7 may be paraphrased as an area ratio of a portion excluding the plurality of recesses 9 in the crystalline region 7. When the area ratio of the crystalline phase is within the above range, area ratios (and volume ratios) of the crystalline phase and the amorphous phase exposed on the crystalline region 7 are easily adjusted appropriately, and the above effect due to the mixture of the crystalline phase and the amorphous phase in the crystalline region 7 is easily obtained. For a similar reason, an area ratio of the crystalline phase in the entire surface F may also be from 0.18 to 0.90, or from 0.180 to 0.757.

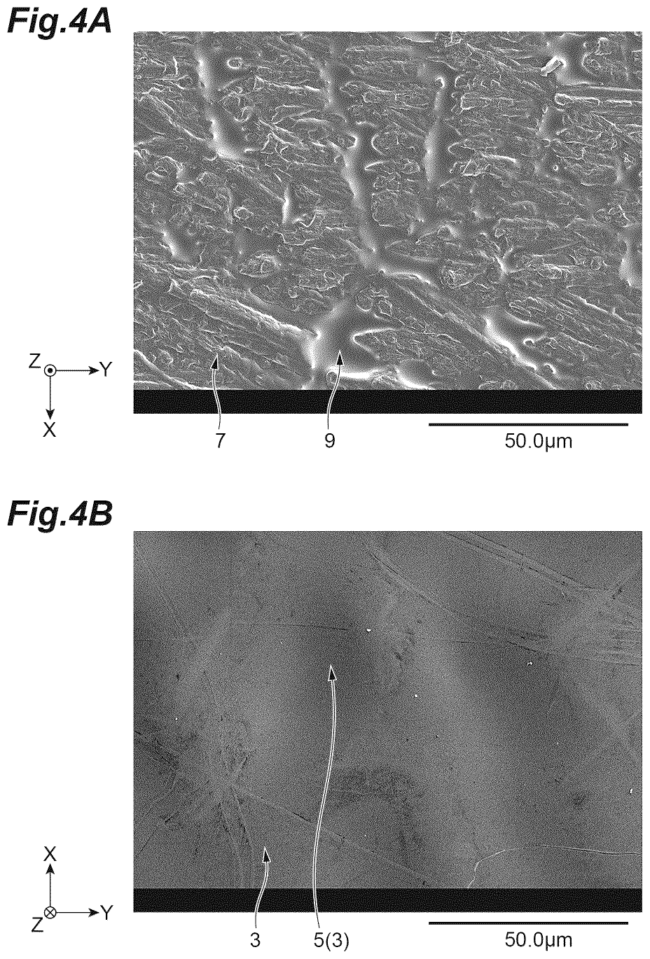

FIG. 4A is a backscattered electron image of the crystalline region 7 taken by SEM, and shows the crystalline region 7 enlarged by 1000 times.

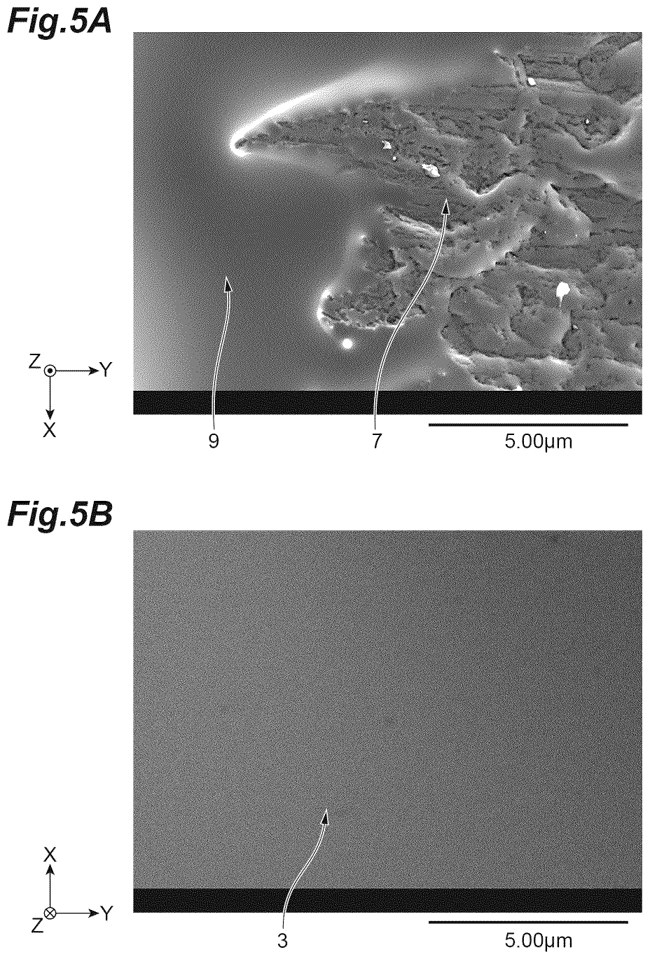

FIG. 5A is also a backscattered electron image of the crystalline region 7 taken by SEM, and shows the crystalline region 7 enlarged by 10000 times.

In a flat portion of the crystalline region 7 excluding the plurality of recesses 9, the crystalline phase of the alloy is exposed. For example, as shown in FIG. 5A, in a flat portion of the crystalline region 7 excluding the plurality of recesses 9, there is a fine structure (alloy crystal grains) having a width of less than about 1 μm. On the other hand, no fine structure is observed in each of the recesses 9. Furthermore, each of the recesses 9 in the crystalline region 7 is distinguished from other portions (crystalline phase exposed on the flat portion) on the basis of a contrast. That is, each of the recesses 9 in the crystalline region 7 can be distinguished from other portions on the basis of presence or absence of a fine structure (crystal grains) and a contrast in the backscattered electron image.

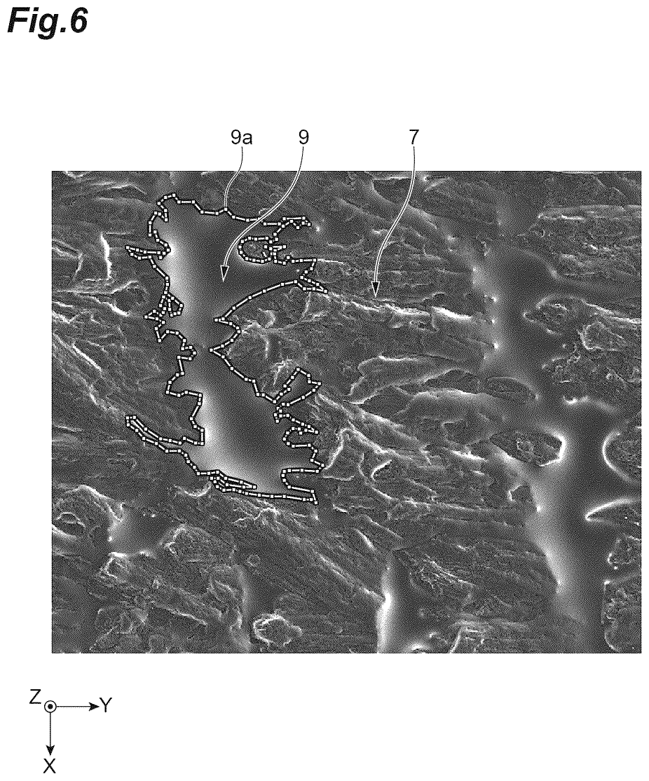

An area ratio of the crystalline phase in the crystalline region 7 may be measured in a backscattered electron image of the crystalline region 7 enlarged by 1000 times. In the measurement of the area ratio of the crystalline phase in the crystalline region 7, threshold processing (binarization processing) of the backscattered electron image based on a red-green-blue (RGB) color model is performed. By the binarization processing, a monochrome image is obtained from the backscattered electron image. On the basis of a contrast in the monochrome image, each of the recesses 9 in the crystalline region 7 is distinguished from other portions, and the area (opening area) of each of the recesses 9 is measured. For example, as shown in FIG. 6, a contour line 9a of each of the recesses 9 in the crystalline region 7 is identified, and each of the recesses 9 is distinguished from other portions on the basis of the contour line 9a. A value obtained by subtracting a sum of the areas of all the recesses 9 in the crystalline region 7 from the total area A_{WHOLE} of the crystalline region 7 (monochrome image) may be regarded as the area A_{C} of the crystalline phase in the crystalline region 7. An area ratio (unit: none) of the crystalline phase in the crystalline region 7 may be expressed by A_{C}/A_{WHOLE}. The area A_{C} of the crystalline phase means the area of the crystalline phase observed from a direction perpendicular to the surface F. The area of each of the recesses 9 also means the area of each of the recesses 9 observed from the direction perpendicular to the surface F. Image processing software (for example, ImageJ which is public domain image processing software) may be used for the above image processing and measurement of each area.

A circumferential length of one recess 9 observed from the direction perpendicular to the surface F is represented by L. As shown in FIG. 6, the circumferential length of one recess 9 means the entire length of the contour line 9a of one recess 9. The area of the one recess 9 observed from the direction perpendicular to the surface F is represented by A. When the amorphous phase is exposed in at least one or all of the plurality of recesses 9, L²/A may be from 100 to 400, or from 143 to 156.

When L²/A is within the above range, a large number of portions where the crystalline phase and the amorphous phase are in contact with each other are likely to be present in the crystalline region 7, and therefore the above effect due to the mixture of the crystalline phase and the amorphous phase in the crystalline region 7 is easily obtained.

The circumferential length L of one recess 9 may be measured on a surface of the crystalline region 7 enlarged by 1000 times (for example, the backscattered electron image of FIG. 4A or FIG. 6) similarly to the area ratio of the crystalline phase. The circumferential length L of one recess 9 may be measured in the backscattered electron image that has been subjected to the binarization processing similarly to the area ratio of the crystalline phase.

The volume of the crystalline phase included in the ribbon 4 may be represented by V_{C}. The volume of the amorphous phase included in the ribbon 4 may be represented by V_{A}. V_{C}/(V_{C}+V_{A}) may be more than 0 and 0.40 or less, or from 0.02 to 0.38.

A part of a portion that was the inside of the ribbon 4 before pulverization is exposed as a part of a surface of an alloy powder obtained by pulverizing the ribbon 4. When V_{C}/(V_{C}+V_{A}) is within the above range, since the volume ratios of the crystalline phase and the amorphous phase inside the ribbon 4 are appropriately adjusted, area ratios (and volume ratios) of the crystalline phase and the amorphous phase in a portion, that is derived from the inside of the ribbon 4 before pulverization, in the surface of the alloy powder are also easily adjusted appropriately. When the area ratios (and volume ratios) of the crystalline phase and the amorphous phase in the surface of the alloy powder have already been adjusted appropriately at the hot pressing step, the above effect due to the mixture of the crystalline phase and the amorphous phase in the crystalline region 7 is easily obtained.

V_{C} and V_{A} may be calculated from an X-ray diffraction spectrum of either the ribbon 4 or the alloy powder obtained by pulverizing the ribbon 4. As a standard sample to be compared with the X-ray diffraction spectrum of the ribbon 4 or the alloy powder, an X-ray diffraction spectrum (spectrum C) of a ribbon composed only of a crystalline phase and an X-ray diffraction spectrum (spectrum A) of a ribbon composed only of an amorphous phase may be measured. V_{C} and V_{A} may be calculated by scale analysis based on the spectrum C and the spectrum A. Analysis software for X-ray diffraction spectrum (for example, HighScore Plus™ manufactured by Malvern Panalytical Ltd.) may be used for the scale analysis. Background may be subtracted from each X-ray diffraction spectrum before the scale analysis.

The crystalline phase may be exposed in all of the plurality of recesses 9. That is, a surface of each of all the recesses 9 formed in the crystalline region 7 may be the crystalline phase. In a portion where the amorphous phase is aggregated on a surface of the ribbon 4 and the crystalline phase is not present in the vicinity thereof, coarse crystal grains of the alloy are easily formed due to rapid crystallization of the alloy during the hot pressing step. The coarse crystal grains reduce a coercivity of the hot deformed magnet. However, when the crystalline phase is exposed in all of the plurality of recesses 9, rapid crystallization of the alloy in the crystalline region 7 including the plurality of recesses 9 is suppressed, coarse crystal grains are hardly formed, and a decrease in a coercivity is suppressed. For a similar reason, only the crystalline phase may be exposed on the entire surface F (including the plurality of recesses 9).

As described above, according to the present embodiment, even when the hot pressing temperature is low to such an extent that formation of coarse crystal grains is suppressed, formation of coarse crystal grains during the hot pressing step is suppressed without sacrificing the residual magnetic flux density of the hot deformed magnet, and a high coercivity of the hot deformed magnet is easily obtained.

A part or the whole of the surface R or the amorphous region 3 may be a flat surface. As shown in FIG. 2, the surface R or the amorphous region 3 may include a plurality of recessed (smooth) curved surfaces 5. That is, a part of the surface R or the amorphous region 3 may be the recessed curved surface 5. The plurality of recessed curved surfaces 5 formed in the surface R or the amorphous region 3 become gaps between the plurality of ribbons 4, and suppresses adhesion between the plurality of ribbons 4 similarly to the plurality of recesses 9 formed in the crystalline region 7. That is, the plurality of recessed curved surfaces 5 contribute to an increase in density of the compact at an early stage of the hot pressing step similarly to the plurality of recesses 9 formed in the crystalline region 7.

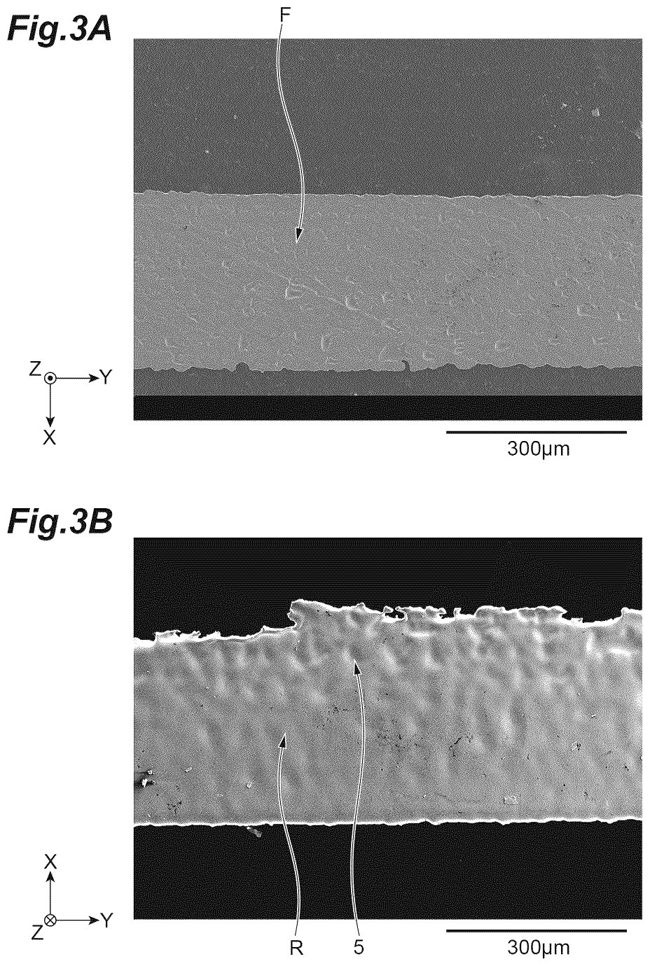

FIG. 3B is a backscattered electron image of the surface R (surface R including the amorphous region 3) taken by an SEM, and shows the surface R enlarged by 150 times. In FIG. 3B, the plurality of recessed curved surfaces 5 (portions darker than surroundings) are observed.

FIG. 4B is a backscattered electron image of the amorphous region 3 (a part of the surface R) taken by an SEM, and shows the amorphous region 3 enlarged by 1000 times. Also in FIG. 4B, the plurality of recessed curved surfaces 5 are observed.

For example, the thickness of the ribbon 4 may be from 10 μm to 60 μm. For example, the length of the ribbon 4 may be about several cm. For example, the width of the ribbon 4 may be from 0.5 mm to 5.0 mm. For example, the maximum width of each of the recesses 9 formed in the crystalline region 7 may be from 3 μm to 20 μm. In other words, the maximum width of one recess observed from the direction perpendicular to the surface F may be from 3 μm to 20 μm. For example, the depth of each of the recesses 9 formed in the crystalline region 7 may be from 0.1 μm to 1.0 μm.

### (Hot Deformed Magnet)

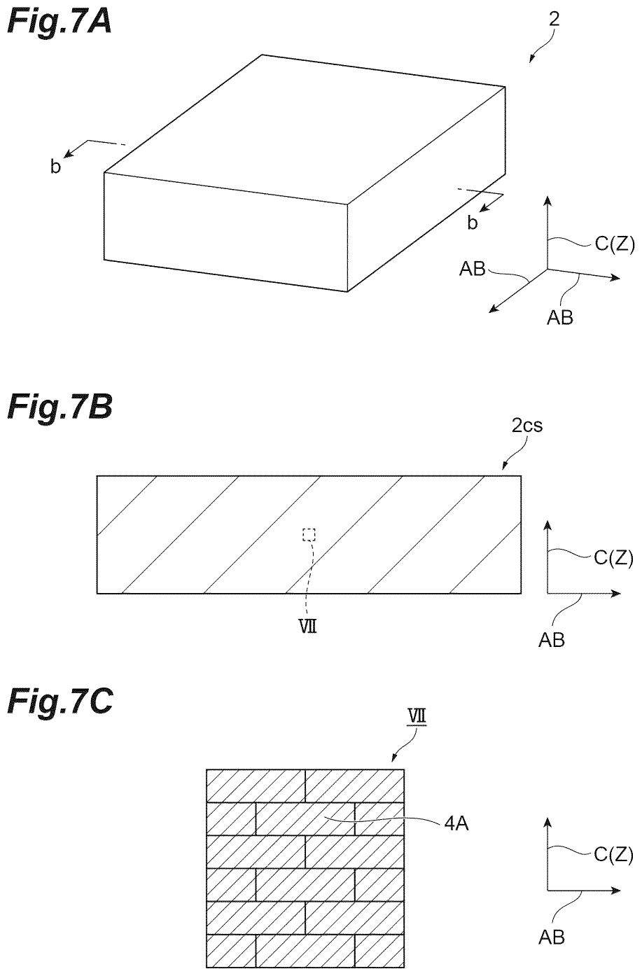

The compact obtained through the hot pressing step becomes a hot deformed magnet through a hot deforming step. FIG. 7A is a perspective view of a hot deformed magnet 2. FIG. 7B is a schematic view of a cross section 2cs of the hot deformed magnet 2. FIG. 7C is an enlarged view of a part (region VII) of the cross section of FIG. 7B. The cross section 2cs of the hot deformed magnet 2 is substantially or completely parallel to the easy magnetization axis direction C of the hot deformed magnet 2. The easy magnetization axis direction C is a direction parallel to a straight line connecting a pair of magnetic poles of the hot deformed magnet 2. That is, the easy magnetization axis direction C is a direction directed from the S-pole of the hot deformed magnet 2 to the N-pole of the hot deformed magnet 2. An AB direction is perpendicular to the easy magnetization axis direction C. As shown in FIG. 7C, the hot deformed magnet 2 includes a plurality of main phase grains 4A. The plurality of main phase grains 4A observed in the cross section 2cs parallel to the easy magnetization axis direction C have a platelet shape. The plurality of platelet-shaped main phase grains 4A are derived from the plurality of ribbons 4 described above. The plurality of platelet-shaped main phase grains 4A are stacked in the easy magnetization axis direction C.

For example, the hot deformed magnet 2 may be applied to a motor, a generator, or an actuator. For example, the hot deformed magnet 2 may be used in various fields such as a hybrid vehicle, an electric vehicle, a hard disk drive, a magnetic resonance imaging device (MRI), a smartphone, a digital camera, a flat type TV, a scanner, an air conditioner, a heat pump, a refrigerator, a vacuum cleaner, a washing and drying machine, an elevator, and a wind power generator.

### (Method for Manufacturing Each of Ribbon and Hot Deformed Magnet)

A method for manufacturing a hot deformed magnet according to the present embodiment includes at least a ribbon preparation step, a pulverization/classification step, a hot pressing step, and a hot deforming step. The method for manufacturing a hot deformed magnet may further include other steps such as a grain boundary diffusion step. Note that the grain boundary diffusion step is not essential.

In order to suppress oxidation of a hot deformed magnet and an in-process product thereof in the manufacturing process, the method for manufacturing a hot deformed magnet may be performed in a non-oxidizing atmosphere. For example, the non-oxidizing atmosphere may be an inert gas such as an argon (Ar) gas. The non-oxidizing atmosphere may further contain a reducing gas such as a hydrogen gas (H₂) in addition to the inert gas.

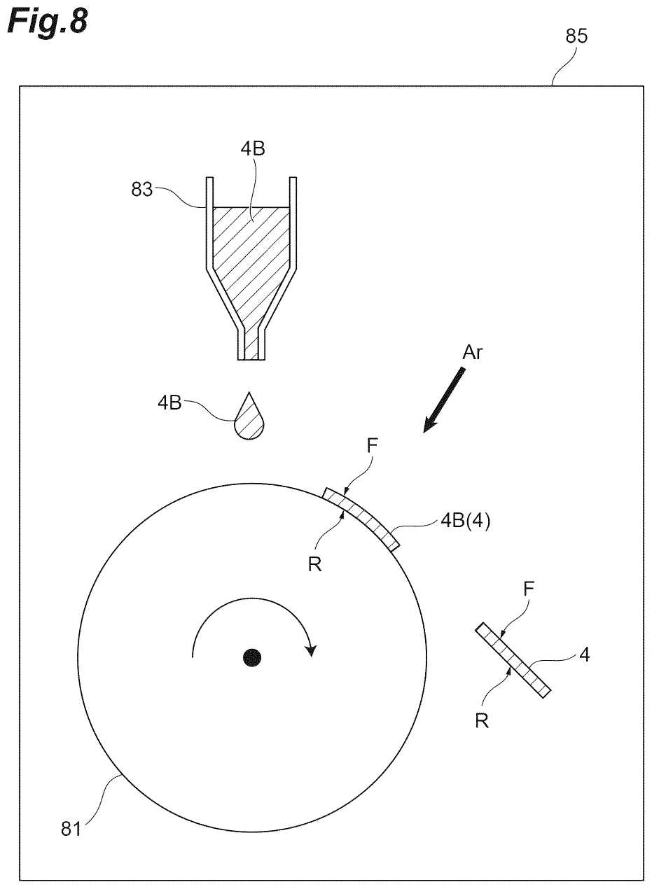

The ribbon preparation step is a step of preparing a large number of the ribbons 4 from a plurality of types of raw material metals by a rapid-solidification method. An outline of the rapid-solidification method is shown in FIG. 8. In the rapid-solidification method, a molten metal 4B in a crucible 83 is ejected from a nozzle located at a tip of the crucible 83 to a surface of a cooled roll 81. The molten metal 4B comes into contact with the surface of the cooled roll 81. By the contact with the surface of the cooled roll 81, the molten metal 4B is rapidly cooled and solidified to become an elongated ribbon (that is, the ribbon 4). A portion of the molten metal 4B in contact with the surface of the cooled roll 81 becomes the surface R of the ribbon 4, and a portion of the molten metal 4B not in contact with the surface of the cooled roll 81 becomes the surface F of the ribbon 4. The ribbon 4 formed on the surface of the cooled roll 81 is instantly flicked by the cooled roll 81 rotating at a high speed. In a direction in which the ribbon 4 is flicked, a container for the ribbon 4 is disposed, and the ribbon 4 is collected into the container. A large number of the ribbons 4 are prepared by the above method.

The crucible 83 containing the molten metal 4B and the cooled roll 81 are disposed in a chamber 85. That is, the ribbon 4 is prepared in the chamber 85. During the execution of the rapid-solidification method, an Ar gas is continuously supplied into the chamber 85 at a predetermined wind speed. During the execution of the rapid-solidification method, an air pressure P_{IN} in the chamber 85 is maintained at a predetermined value. A difference between the air pressure P_{IN} in the chamber 85 and an atmospheric pressure P_{ATM} is expressed by ΔP (=P_{IN}−P_{ATM}). For example, ΔP may be from 0.0 kPa to 1.5 kPa. As ΔP is lower, the crystalline phase tends to be more easily exposed in each of the recesses 9 formed in the crystalline region 7. As ΔP is higher, the amorphous phase tends to be more easily exposed in each of the recesses 9 formed in the crystalline region 7. For example, the wind speed of the Ar gas supplied into the chamber 85 may be from 9 m/s to 49 m/s. When the wind speed of the Ar gas is zero m/sec, the plurality of recesses 9 tends to be hardly formed in the crystalline region 7. When the wind speed of the Ar gas is more than zero m/s and less than 9 m/s, the amorphous region 3 is hardly formed on the surface R, and only the crystalline phase of the alloy tends to be easily exposed on the entire surface R.

The molten metal is a metal (a plurality of types of raw material metals) containing a plurality of types of elements constituting the hot deformed magnet. For example, the plurality of types of raw material metals may include a simple substance (metal simple substance) of a rare earth element or another element, an alloy containing a rare earth element or another element, pure iron, or ferroboron. The plurality of types of raw material metals are weighed so as to match a desired composition of the hot deformed magnet.

The molten metal may be obtained by heating the plurality of types of raw material metals in the crucible by high frequency induction heating. For example, the temperature (ejection temperature) of the molten metal ejected from the nozzle may be from 1200° C. to 1400° C. For example, a temperature rising rate until the temperature of the plurality of types of raw material metals reaches the ejection temperature may be about 20 to 100° C./sec.

The surface of the cooled roll may be composed of a metal having high thermal conductivity, such as Cu. The temperature of the surface of the cooled roll may be controlled by a refrigerant flowing in the cooled roll. For example, the temperature of the surface of the cooled roll may be controlled such that a cooling rate of the molten metal on the surface of the cooled roll is about 10⁵ to 10⁶° C./sec. As the cooling rate is higher, a grain diameter of the crystal (R₂T₁₄B) contained in the ribbon 4 tends to become finer, and a coercivity of the hot deformed magnet tends to increase. As the amount of the molten metal ejected to the surface of the cooled roll per unit time is smaller, the molten metal adhering to the surface of the cooled roll becomes thinner, the cooling rate becomes higher, and the ribbon 4 also becomes thinner. As a peripheral speed of the cooled roll is higher, the molten metal adhering to the surface of the cooled roll becomes thinner, the cooling rate becomes higher, and the ribbon 4 also becomes thinner. The thickness of the main phase grain 4A in the easy magnetization axis direction (the length of a short axis of the main phase grain 4A) depends on the thickness of the ribbon 4 (and pulverization and classification of the ribbon 4). As the ribbon 4 is thinner, the thickness (grain diameter) of the main phase grain 4A becomes smaller, and the coercivity of the hot deformed magnet tends to increase.

After the ribbon preparation step, the pulverization/classification step may be performed. The pulverization/classification step is a step of pulverizing the ribbon 4 to obtain an alloy powder. For example, the pulverization/classification step may be a step of pulverizing the ribbon 4 using a pulverizer to prepare a coarse powder, and classifying the coarse powder to collect an alloy powder having a predetermined particle diameter and aspect ratio. The alloy powder is a precursor of the main phase grain 4A contained in the hot deformed magnet. The shape of each alloy particle constituting the alloy powder may be a plate shape or a flake shape. For example, a method for pulverizing the ribbon 4 may be at least one of a cutter mill and a propeller mill. A means for classifying a coarse powder may be a sieve. A particle diameter and particle size distribution of the alloy powder obtained by classification may be measured by, for example, a laser diffraction scattering method. The particle diameter of the alloy powder obtained by classification may be, for example, from 60 μm to 2800 μm.

The hot pressing step is a step of obtaining a compact by pressurizing the ribbons 4 (alloy powder) while heating the ribbons 4. For example, the alloy powder may be compressed with a die while heating the alloy powder in the die. By pressurizing the alloy powder, voids between particles of the alloy powder are reduced to obtain a dense compact. In addition, a liquid phase (R-rich phase such as a Nd-rich phase) is formed from a surface of the alloy powder by heating the alloy powder with pressurization, and the liquid phase fills voids (grain boundaries) between particles of the alloy powder. The alloy powder is lubricated by the liquid phase, whereby the alloy powder is easily compressed, and a dense compact is easily obtained. A cold pressing step may be performed before the hot pressing step. In the cold pressing step, a compact may be formed by pressurizing the alloy powder at normal temperature (room temperature). A compact obtained through the cold pressing step may be densified by pressurizing the compact while heating the compact in the hot pressing step. For example, the temperature (hot pressing temperature) of the alloy powder in the hot pressing step may be from 550° C. to 800° C. When the hot pressing temperature is too low, a sufficient liquid phase is not formed from a surface of the alloy powder, and the compact is hardly densified. When the hot pressing temperature is too high, grain growth of the crystal (R₂T₁₄B) constituting the alloy powder excessively proceeds, and a coercivity of the hot deformed magnet tends to decrease. For example, a pressure (hot pressing pressure) applied to the alloy powder in the hot pressing step may be from 50 MPa to 200 MPa. For example, a time (hot pressing time) during which the hot pressing temperature and the hot pressing pressure are maintained in the above ranges may be from several tens of seconds to several hundreds of seconds.

After the hot pressing step, the hot deforming step is performed. The hot deforming step is a step of obtaining a magnet base material by hot-deforming the compact obtained through the hot pressing step. For example, in the hot deforming step, by heating and pressurizing the compact, a magnet base material containing the plurality of main phase grains 4A (crystal grains of R₂T₁₄B) in which the c-axis (easy magnetization axis) is oriented in a predetermined direction is obtained. For example, die upset forging may be performed as the hot deforming step. For example, hot extrusion may be performed as the hot deforming step.

By heating during the hot deforming step, a grain boundary phase in the compact is liquefied to generate a liquid phase (R-rich phase). By pressurization during the hot deforming step, stress acts on the compact in a predetermined direction, and each alloy particle (ribbon 4) constituting the compact is distorted. Anisotropic growth of crystal grains in a direction perpendicular to the c-axes of the crystal grains proceeds along with generation of the liquid phase and distortion of the alloy particle. In addition, the liquid phase lubricates each crystal grain, and a force acts on each crystal grain according to stress. As a result, the crystal grains rotate by grain boundary sliding, and the c-axis of each crystal grain (main phase grain 4A) is oriented parallel to a stress direction. In other words, the plurality of platelet-shaped main phase grains 4A extending in directions perpendicular to their c-axes are stacked in the stress direction. The easy magnetization axis direction of the magnet base material is substantially or completely parallel to the stress direction.

For example, the temperature (hot deforming temperature) of the compact in the hot deforming step may be 700° C. or higher and lower than 900° C., or from 700° C. to 850° C.

When the hot deforming temperature is too low, a liquid phase (R-rich phase such as a Nd-rich phase) is hardly generated at a grain boundary in the compact, crystal grains are hardly grown, and rotation of the crystal grains due to grain boundary sliding hardly occurs. As a result, an average value of the lengths of the short axes of the main phase grains 4A tends to be less than 20 nm, and the c-axis of each of the main phase grains 4A (crystal grains) is hardly oriented parallel to the stress direction.

When the hot deforming temperature is too high (for example, when the hot deforming temperature is 900° C. or higher), the liquid phase (R-rich phase) excessively exudes from each alloy particle and segregates at a surface of each alloy particle and an interface between the alloy particles, and most of the liquid phase is consumed for grain growth of crystal grains. Since most of the liquid phase is consumed for grain growth of the crystal grains, grain growth of the main phase grains 4A (crystal grains) proceeds abnormally, the coarse main phase grains 4A are easily formed, and the average value of the lengths of the short axes of the main phase grains 4A tends to exceed 200 nm. The coarse main phase grains 4A are hardly oriented in the easy magnetization axis direction.

For example, a pressure (hot deforming pressure) applied to the compact in the hot deforming step may be from 50 MPa to 200 MPa. For example, a time (hot deforming time) during which the hot deforming temperature and the hot deforming pressure are maintained in the above ranges may be several tens of seconds.

The magnet base material obtained through the above steps may be a finished product of a hot deformed magnet. A magnet base material that has been subjected to the following grain boundary diffusion step may be a finished product of a hot deformed magnet.

After the hot deforming step, the following grain boundary diffusion step may be performed. The grain boundary diffusion step is a step of attaching a diffusing material containing a heavy rare earth element to a surface of the magnet base material and heating the diffusing material and the magnet base material. By heating the magnet base material to which the diffusing material is attached, the heavy rare earth elements in the diffusing material are diffused from the surface of the magnet base material to the inside of the magnet base material. In the magnet base material, the heavy rare earth elements diffuse to the vicinity of a surface of the main phase grain 4A via a grain boundaries. In the vicinity of the surface of the main phase grain 4A, some light rare earth elements (Nd and the like) are replaced with the heavy rare earth elements. The heavy rare earth elements are localized in the vicinity of the surface of the main phase grain 4A and at the grain boundaries, whereby an anisotropic magnetic field locally increases in the vicinity of the grain boundary, and a nucleus of magnetization reversal is hardly generated in the vicinity of the grain boundaries. As a result, a hot deformed magnet having a high coercivity is obtained.

For example, the temperature (diffusion temperature) of the diffusing material and the magnet base material in the grain boundary diffusion step may be from 550° C. to 900° C. For example, a time (diffusion time) during which the diffusion temperature is maintained in the above range may be from 1 minute to 1440 minutes.

The diffusing material may contain at least one heavy rare earth element of Tb and Dy. The diffusing material may further contain at least one light rare earth element of Nd and Pr in addition to the heavy rare earth element. The diffusing material may further contain a metal other than a rare earth element, such as Cu or Al, in addition to the heavy rare earth element and the light rare earth element. For example, the diffusing material may be a metal consisting of one of the above elements, a hydride of one of the above elements, an alloy containing the above plurality of types of elements, or a hydride of the alloy. The diffusing material may be a powder. In the grain boundary diffusion step, a slurry containing the diffusing material and an organic solvent may be applied to a surface of the magnet base material. In the grain boundary diffusion step, the surface of the magnet base material may be covered with a sheet including the diffusing material and a binder. In the grain boundary diffusion step, the surface of the magnet base material may be covered with an alloy foil (ribbon) composed of the diffusing material.

In order to promote diffusion of the diffusing material, the surface of the magnet base material may be polished before the grain boundary diffusion step. In order to remove the diffusing material remaining on the surface of the magnet base material after the grain boundary diffusion step, the surface of the magnet base material after the grain boundary diffusion step may be polished.

The size and shape of the magnet base material may be adjusted by, for example, cutting and polishing the magnet base material. A passive layer may be formed on the surface of the magnet base material by oxidation or chemical treatment of the surface of the magnet base material. The surface of the magnet base material may be covered with a protective film such as a resin film. The passive layer or the protective film improves corrosion resistance of the hot deformed magnet.

The present disclosure is not necessarily limited to the above-described embodiment. Various modifications of the present disclosure are possible without departing from the gist of the present disclosure, and such modifications are also included in the technical scope of the present disclosure.

### EXAMPLES

The present disclosure will be described in detail by the following Examples and Comparative Examples. The present disclosure is not limited by the following Examples.

### Example 1

Each step of the following Example 1 was performed in a non-oxidizing atmosphere (Ar gas).

In a ribbon preparation step, a plurality of ribbons were prepared from a molten metal containing a plurality of types of raw material metals by the above-described rapid-solidification method shown in FIG. 8. The molten metal was maintained at about 1200° C. The temperature of a surface of a cooled roll was maintained at approximately room temperature. The above-described ΔP was maintained at a value shown in Table 1 below. A wind speed V_{Ar} of an Ar gas supplied into a chamber was maintained at a value shown in Table 1 below.

The molten metal contained Nd, Pr, Fe, B, Ga, and Co.

The content of Nd in the molten metal was 30.17% by mass.

The content of Pr in the molten metal was 0.13% by mass.

The content of Fe in the molten metal was 64.25% by mass.

The content of B in the molten metal was 0.90% by mass.

The content of Ga in the molten metal was 0.59% by mass.

The content of Co in the molten metal was 3.96% by mass.

A plurality of backscattered electron images of each of a pair of surfaces of the ribbon of Example 1 were taken by an SEM. From the plurality of backscattered electron images, the following plurality of features of the ribbon of Example 1 were identified.

The ribbon had a surface R and a surface F located on a back side of the surface R.

The surface R included the amorphous region 3 where only an amorphous phase of an alloy was exposed.

The surface F included the crystalline region 7 where at least a crystalline phase of the alloy was exposed.

The plurality of recesses 9 were formed in the crystalline region 7.

The amorphous phase was exposed in each of the plurality of recesses 9.

The surface R did not include the crystalline region 7 where the plurality of recesses 9 were formed.

A plurality of backscattered electron images of the surface F of the ribbon of Example 1 are shown in FIG. 3A, FIG. 4A, FIG. 5A, and FIG. 6.

A plurality of backscattered electron images of the surface R of the ribbon of Example 1 are shown in FIG. 3B, FIG. 4B, and FIG. 5B.

The surface R enlarged by 150 times (backscattered electron image in FIG. 3B) included a plurality of recessed curved surfaces.

An area ratio A_{C}/A_{WHOLE} of the crystalline phase in the crystalline region 7 enlarged by 1000 times (backscattered electron image in FIG. 4A) was measured.

L²/A was measured in the crystalline region 7 enlarged by 1000 times (backscattered electron image in FIG. 4A).

As in the above embodiment, in the measurement of each of A_{C}/A_{WHOLE} and L²/A, binarization processing of the backscattered electron image using image processing software (ImageJ) was performed.

V_{C}/(V_{C}+V_{A}) was measured by the method described in the above embodiment.

A_{C}/A_{WHOLE}, L²/A, and V_{C}/(V_{C}+V_{A}) of Example 1 are shown in Table 2 below. Note that L²/A of Example 1 was measured in five recesses 9. L²/A of Example 1 shown in Table 2 below is an average value in the five measurements.

By pulverizing the plurality of ribbons, an alloy powder was prepared. In a hot pressing step, a compact (that is, a hot deformed magnet) was prepared by compressing the alloy powder with a die while heating the alloy powder in the die. The compact was a rectangular parallelepiped. The dimension of the compact was 22 mm×11 mm×30 mm. The hot pressing temperature T (unit: ° C.) was a value shown in Table 1 below. The hot pressing pressure was 150 MPa. The hot pressing time was 240 seconds.

A compact of Example 1 was prepared by the above method. A bulk density (unit: g/cc) of the compact was measured five times by an Archimedes method. An average value of the bulk densities measured five times is shown in Table 2 below. A relative density of the compact was calculated by dividing the average value of the bulk densities of the compact by a density (7.607 g/cc) of a single crystal of Nd₂Fe₁₄B. That is, the relative density of the compact is a ratio (unit:%) of the average value of the bulk densities of the compact to the density of the single crystal of Nd₂Fe₁₄B. The relative density of the compact is shown in Table 2 below.

A residual magnetic flux density (Bᵣ) and a coercivity (Hₑj) of the compact (that is, the hot deformed magnet) were measured at room temperature. The residual magnetic flux density and the coercivity were measured by a BH tracer. The residual magnetic flux density (unit: T) and the coercivity (unit: kA/m) are shown in Table 2 below.

### Examples 2 to 8 and Comparative Examples 1 to 5

In the rapid-solidification method of each of Examples 2 to 8 and Comparative Examples 1 to 5, each of ΔP and V_{Ar} was maintained at a value shown in Table 1 below. Note that, in Comparative Examples 1, 2, 4, and 5, an Ar gas was supplied to the inside of the chamber 85 in advance to adjust ΔP to a predetermined value, and then the rapid-solidification method was performed in a state where the supply of the Ar gas to the inside of the chamber 85 was stopped. Therefore, in Table 1 below, V_{Ar} of each of Comparative Examples 1, 2, 4, and 5 is expressed by zero m/sec.

A plurality of ribbons of each of Examples 2 to 8 and Comparative Examples 1 to 5 were prepared in the same manner as in Example 1 except for ΔP and V_{Ar}. The ribbons of each of Examples 2 to 8 and Comparative Examples 1 to 5 were analyzed in the same manner as in Example 1. Note that measurements of A_{C}/A_{WHOLE} and L²/A were performed only in Examples 2 to 4. Measurement of V_{C}/(V_{C}+V_{A}) was performed only in Examples 2 to 5 and Comparative Examples 2. A_{C}/A_{WHOLE} and L²/A of each of Examples 2 to 4 are shown in Table 2 below. V_{C}/(V_{C}+V_{A}) of each of Examples 2 to 5 and Comparative Examples 2 is shown in Table 2 below.

The ribbons of each of Examples 2 to 4 had the above plurality of the same features as those of Example 1 except for A_{C}/A_{WHOLE}, L²/A, and V_{C}/(V_{C}+V_{A}).

In each of the plurality of recesses 9 formed in the crystalline region 7 of Example 5, not the amorphous phase but the crystalline phase was exposed. V_{C}/(V_{C}+V_{A}) of Example 5 was a value shown in Table 2 below. Except for these features, the ribbons of Example 5 had the above plurality of the same features as those of Example 1.

The surface F in Comparative Example 1 was flat, and only the amorphous phase of the alloy was exposed on the entire surface F in Comparative Example 1. That is, the surface F in Comparative Example 1 did not include the crystalline region 7 where the plurality of recesses 9 were formed.

The surface R of Comparative Example 1 included the amorphous region 3 where only the amorphous phase of the alloy was exposed. The surface R of Comparative Example 1 did not include the crystalline region 7. That is, only the amorphous phase of the alloy was exposed on the entire surface R of Comparative Example 1. The surface R of Comparative Example 1 included a plurality of recessed curved surfaces.

The surface F of Comparative Example 2 was flat, and only the crystalline phase of the alloy was exposed on the entire surface F of Comparative Example 2. That is, the surface F of Comparative Example 2 did not include the crystalline region 7 where the plurality of recesses 9 were formed.

The surface R of Comparative Example 2 did not include the amorphous region 3 where only the amorphous phase of the alloy was exposed. Only the crystalline phase of the alloy was exposed on the entire surface R of Comparative Example 2. The surface R of Comparative Example 2 included a plurality of recessed curved surfaces.

In each of the plurality of recesses 9 formed in the crystalline region 7 of Example 6, not the amorphous phase but the crystalline phase was exposed. Except for this feature, the ribbons of Example 6 had the above plurality of the same features as those of Example 1.

In each of the plurality of recesses 9 formed in the crystalline region 7 of Example 7, not the amorphous phase but the crystalline phase was exposed. In the flat portion of the crystalline region 7 of Example 7 excluding the plurality of recesses 9, both the crystalline phase and the amorphous phase were mixed. Except for these features, the ribbons of Example 7 had the above plurality of the same features as those of Example 1.

In each of the plurality of recesses 9 formed in the crystalline region 7 of Example 8, not the amorphous phase but the crystalline phase was exposed. Except for this feature, the ribbons of Example 8 had the above plurality of features similar to those of Example 1.

The surface F of Comparative Example 3 included the crystalline region 7 where the plurality of recesses 9 were formed. In each of the plurality of recesses 9 formed in the crystalline region 7 of Comparative Example 3, not the amorphous phase but the crystalline phase was exposed.

The surface R of Comparative Example 3 did not include the amorphous region 3 where only the amorphous phase of the alloy was exposed. Only the crystalline phase of the alloy was exposed on the entire surface R of Comparative Example 3. The surface R of Comparative Example 3 included a plurality of recessed curved surfaces.

The surface F of Comparative Example 4 was flat, and only the amorphous phase of the alloy was exposed on the entire surface F of Comparative Example 4. That is, the surface F of Comparative Example 4 did not include the crystalline region 7 where the plurality of recesses 9 were formed.

The surface R of Comparative Example 4 included the amorphous region 3 where only the amorphous phase of the alloy was exposed. The surface R of Comparative Example 4 did not include the crystalline region 7. That is, only the amorphous phase of the alloy was exposed on the entire surface R of Comparative Example 4. The surface R of Comparative Example 4 included a plurality of recessed curved surfaces.

The surface F of Comparative Example 5 was flat, and only the crystalline phase of the alloy was exposed on the entire surface F of Comparative Example 5. That is, the surface F of Comparative Example 5 did not include the crystalline region 7 where the plurality of recesses 9 were formed.

The surface R of Comparative Example 5 did not include the amorphous region 3 where only the amorphous phase of the alloy was exposed. Only the crystalline phase of the alloy was exposed on the entire surface R of Comparative Example 5. The surface R of Comparative Example 5 included a plurality of recessed curved surfaces.

The features of the ribbons of each of Examples 2 to 8 and Comparative Examples 1 to 5 are summarized in Table 1 below.

The hot pressing temperature T of each of Examples 2 to 8 and Comparative Examples 1 to 5 was a value shown in Table 1 below. A compact of each of Examples 2 to 8 and Comparative Examples 1 to 5 was prepared in the same manner as in Example 1 except for the hot pressing temperature T. A bulk density and a relative density of each of Examples 2 to 8 and Comparative Examples 1 to 5 were measured in the same manner as in Example 1. The bulk density and the relative density of each of Examples 2 to 8 and Comparative Examples 1 to 5 are shown in Table 2 below. A residual magnetic flux density and a coercivity of each of Examples 2 to 5 and Comparative Examples 1 and 2 were measured in the same manner as in Example 1. The residual magnetic flux density and the coercivity of each of Examples 2 to 5 and Comparative Examples 1 and 2 are shown in Table 2 below.

TABLE 1

| | | | | | Surface R | |
|---|---|---|---|---|---|---|
| | | | Surface F | | Recessed | |
| | ΔP | V_{Ar} | | Crystalline | curved | Amorphous |
| | [kPa] | [m/s] | Recess | region | surface | region |
| Example 1 | 0.7 | 21 | present (amorphous) | present | present | present |
| Example 2 | 0.7 | 49 | present (amorphous) | present | present | present |
| Example 3 | 1.5 | 21 | present (amorphous) | present | present | present |
| Example 4 | 1.5 | 49 | present (amorphous) | present | present | present |
| Example 5 | 0.2 | 9 | present (crystalline) | present | present | present |
| Comparative Example 1 | 0.7 | 0 | absent | absent | present | present |
| Comparative Example 2 | 1.2 | 0 | absent | present | present | absent |
| Example 6 | 0.2 | 9 | present (crystalline) | present | present | present |
| Example 7 | 0.0 | 21 | present (crystalline) | present | present | present |
| Example 8 | 0.0 | 9 | present (crystalline) | present | present | present |
| Comparative Example 3 | 0.0 | 5 | present (crystalline) | present | present | absent |
| Comparative Example 4 | 0.7 | 0 | absent | absent | present | present |
| Comparative Example 5 | 1.2 | 0 | absent | present | present | absent |

TABLE 2

| | A_{C}/ | | V_{C}/(V_{C} + | Hot pressing | Bulk | Relative | | |
|---|---|---|---|---|---|---|---|---|
| | A_{WHOLE} | L²/A | V_{A}) | temperature T | density | density | Bᵣ | H_{cj} |
| Unit | [—] | [—] | [%] | [° C.] | [g/cc] | [%] | [T] | [kA/m] |
| Example 1 | 0.554 | 156 | 0.04 | 670 | 7.575 | 99.58% | 1.461 | 1451 |
| Example 2 | 0.757 | 73 | 0.07 | 680 | 7.548 | 99.23% | 1.402 | 1410 |
| Example 3 | 0.926 | 143 | 0.15 | 680 | 7.540 | 99.12% | 1.373 | 1395 |
| Example 4 | 0.180 | 62 | 0.02 | 690 | 7.561 | 99.40% | 1.433 | 1354 |
| Example 5 | — | — | 0.38 | 690 | 7.365 | 96.82% | 1.306 | 1302 |
| Comparative Example 1 | — | — | — | 690 | 7.301 | 95.98% | 1.195 | 1166 |
| Comparative Example 2 | — | — | 1.00 | 690 | 7.314 | 96.15% | 1.238 | 1038 |
| Example 6 | — | — | — | 700 | 7.583 | 99.68% | — | — |
| Example 7 | — | — | — | 700 | 7.555 | 99.31% | — | — |
| Example 8 | — | — | — | 710 | 7.568 | 99.49% | — | — |
| Comparative Example 3 | — | — | — | 720 | 7.535 | 99.06% | — | — |
| Comparative Example 4 | — | — | — | 740 | 7.532 | 99.02% | — | — |
| Comparative Example 5 | — | — | — | 730 | 7.541 | 99.13% | — | — |

In each of Examples 1 to 5 and Comparative Examples 1 and 2, the hot pressing temperature T was lower than 700° C. The bulk density and the relative density of each of Examples 1 to 5 were higher than the bulk density and the relative density of each of Comparative Examples 1 and 2. The residual magnetic flux density of each of Examples 1 to 5 was higher than the residual magnetic flux density of each of Comparative Examples 1 and 2. The coercivity of each of Examples 1 to 5 was higher than the coercivity of each of Comparative Examples 1 and 2.

In each of Examples 6 to 8 and Comparative Examples 3 to 5, the hot pressing temperature T was 700° C. or higher. The bulk density and the relative density of each of Examples 6 to 8 were higher than the bulk density and the relative density of each of Comparative Examples 3 to 5.

### INDUSTRIAL APPLICABILITY

For example, the ribbon according to one aspect of the present disclosure may be applied to a raw material of a hot deformed magnet.

### REFERENCE SIGNS LIST

2: Hot deformed magnet, 2cs: Cross section of hot deformed magnet (cross section parallel to easy magnetization axis direction), 3: Amorphous region, 5: Recessed curved surface, 4: Ribbon, 4A: Main phase grain, 4B: Molten metal, R: Surface R, F: Surface F, 7: Crystalline region, 9: Recess, 81: Cooled roll, 83: Crucible, 85: Chamber, C: Easy magnetization axis direction, AB: Direction perpendicular to easy magnetization axis direction.

What is claimed is:

1. A ribbon containing an alloy containing a rare earth element, iron, and boron, wherein
the ribbon has a surface R and a surface F located on a back side of the surface R,
the surface R includes an amorphous region where only an amorphous phase of the alloy is exposed,
the surface F includes a crystalline region where at least a crystalline phase of the alloy is exposed,
a plurality of recesses are formed in the crystalline region, and
the surface R does not include the crystalline region where the plurality of recesses are formed.

2. The ribbon according to claim 1, wherein
the surface F further includes a region where the amorphous phase is exposed in addition to the crystalline region.

3. The ribbon according to claim 1, wherein
the amorphous phase is exposed in at least one of the plurality of recesses.

4. The ribbon according to claim 1, wherein
the amorphous phase is exposed in at least one of the plurality of recesses, and
an area ratio of the crystalline phase in the crystalline region is from 0.18 to 0.90.

5. The ribbon according to claim 1, wherein
the amorphous phase is exposed in at least one of the plurality of recesses,
a circumferential length of one of the recesses observed from a direction perpendicular to the surface F is represented by L,
an area of the one of the recesses observed from the direction perpendicular to the surface F is represented by A, and
L²/A is from 100 to 400.

6. The ribbon according to claim 1, wherein
the crystalline phase is exposed in all of the plurality of recesses.

7. The ribbon according to claim 1, wherein
the amorphous region includes a plurality of recessed curved surfaces.

8. The ribbon according to claim 1, which is used as a raw material of a hot deformed magnet.

9. The ribbon according to claim 1, wherein
the ribbon has a thickness of from 10 μm to 60 μm.

10. The ribbon according to claim 1, wherein
a volume of the crystalline phase included in the ribbon is represented by V_{C},
a volume of the amorphous phase included in the ribbon is represented by V_{A}, and
V_{C}/(V_{C}+V_{A}) is more than 0 and 0.40 or less.

11. A method for manufacturing a hot deformed magnet,
comprising:
a step of pulverizing the ribbon according to claim 1 to obtain an alloy powder;
a step of pressurizing the alloy powder while heating the alloy powder to obtain a compact; and
a step of hot-deforming the compact to obtain a magnet base material.
